(19) United States
(12) Patent Application Publication
(10) Pub. No.: US 2018/0009513 A1
(43) Pub. Date: Jan. 11, 2018

(54) HIGH-OUTPUT MULTIFUNCTION SUBMERSIBLE MARINE LIGHTING APPARATUS

(71) Applicants: Ryan Christensen, North Salt Lake, UT (US); Eric Nofsinger, North Salt Lake, UT (US)

(72) Inventors: Ryan Christensen, North Salt Lake, UT (US); Eric Nofsinger, North Salt Lake, UT (US)

(21) Appl. No.: 15/206,190

(22) Filed: Jul. 8, 2016

(51) Int. Cl. B63B 45/02; F21V 7/00; F21V 17/12; F21V 5/04; F21V 31/00; F21V 23/04

(52) U.S. Cl. CPC B63B 45/02; F21V 31/005; F21V 23/0442; F21V 17/12; F21V 29/67; F21V 5/048; F21V 7/00; F21Y 2105/10; F21Y 2115/10

(57) ABSTRACT

A submersible marine lighting apparatus is provided which converts electrical input to 25 or 34 volts and provides optimal underwater illumination. The marine lighting apparatus comprises a plano-convex light-focusing lens that concentrates emitted light into a more focused beam, as well a thermal switch and COB LED.

### BACKGROUND OF THE INVENTION

### Field of the Invention

This invention relates to lighting systems and apparati and in particular, to a submersible marine lighting system and apparatus.

### Description of the Related Art

Submersible lights have been used on ships and watercraft for decorative and functional purposes for decades. Lighting has been applied to decks and hulls of watercraft to improve visibility during the night, to illuminate murky waters, and to shine from a distance.

These marine lighting systems have taken many forms. Thru-hull mounted lights comprising high intensity incandescent light bulbs contained within a housing are known in the art. Light shields to redirect the light rays along the surface of the hull are known.

Most marine lighting products have not been waterproof with some exceptions. Marine lights above the waterline fade rapidly as the light source reaches the waterline. Some marine lights in the art have been integrated into the hull of a boat watercraft by placing the lights into the thru-hull fittings positioned below the water-line in order to improve visibility in the surrounding water. By placing the light assembly inside a thru-hull, maintenance can be conducted interiorly to the boat where access is more easily facilitated than outside the boat, but hull integrity is permanently compromised by the large cylindrical thru-hull.

Additionally, traditional marine lighting is static in color and cannot be configured to strobe or flash. Traditional skiboats and pleasure boats running on 12 volt electrical systems do not have the voltage output necessary to optimally power marine lighting with up voltage conversion, which is unknown in the art. Because the output desired by boaters from submersible marine lights is more than can typically be provided by a single marine light at 12 volts, boaters traditionally position a plurality of lights on the hulls of vessels to increase collective output, an inefficiency necessitated by weakness in the art.

With the advent of LEDs and LED arrays replacing incandescent bulbs, there exists a need in the art for a submersible lighting system affixable to the hulls of boats which does not compromise the integrity of the hulls, which are configurable to shine in any number of colors or flashing patterns, and which diffuse higher intensity light than conventional apparati.

### SUMMARY OF THE INVENTION

From the foregoing discussion, it should be apparent that a need exists for a multifunction submersible marine lighting apparatus. Beneficially, such an apparatus would overcome many of the difficulties and concerns expressed above, by providing a multifunction marine lighting apparatus which can be easily installed with multiple lighting functions.

The present invention has been developed in response to the problems and needs in the art that have not yet been fully solved by currently available apparati and methods. Accordingly, the present invention has been developed to provide a submersible light comprising: a base for affixation to a hull of a watercraft, the base defining a recess for receiving an LED array; an LED array; a thermal switch; a plano-convex lens disposed between the base and a retaining ring for focusing light diffusing from the LED array, the plano-convex lens having a circumscribing flange; wherein the retaining ring is bolted to the base.

The apparatus may further comprise a reflector disposed between the plano-convex lens and the base. The retaining ring may be bolted to the base using three flat head screws.

A second submersible marine light is provided comprising: a cylindrical base for affixation to a hull of a watercraft, the base defining a recess for receiving an LED array; an LED array; a thermal switch in logical connectivity with the LED array; a plano-convex lens disposed between the base and a retaining ring for focusing light diffusing from the LED array, the plano-convex lens having a circumscribing flange; a lens gasket disposed between the plano-convex lens and the base; wherein the retaining ring is bolted to the base.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a forward elevational side perspective view of submersible marine light in accordance with the present invention;

FIG. 1B is a forward elevational side perspective view of submersible marine light in accordance with the present invention;

FIG. 2 is a lower perspective view of the base in accordance with the present invention;

FIG. 3 is an elevational side perspective view of a convex lens in accordance with the present invention;

FIG. 4 is an elevational side perspective view of a submersible marine lighting apparatus in accordance with the present invention;

FIG. 5 is a side perspective view of a submersible marine lighting apparatus in accordance with the present invention;

FIG. 6 is a top perspective view of a submersible marine lighting apparatus in accordance with the present invention;

FIG. 7 is an exploded environmental side perspective view of a submersible marine light in accordance with the present invention; and

FIG. 8 is a block diagram of a fan box for controlling input to a submersible light in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

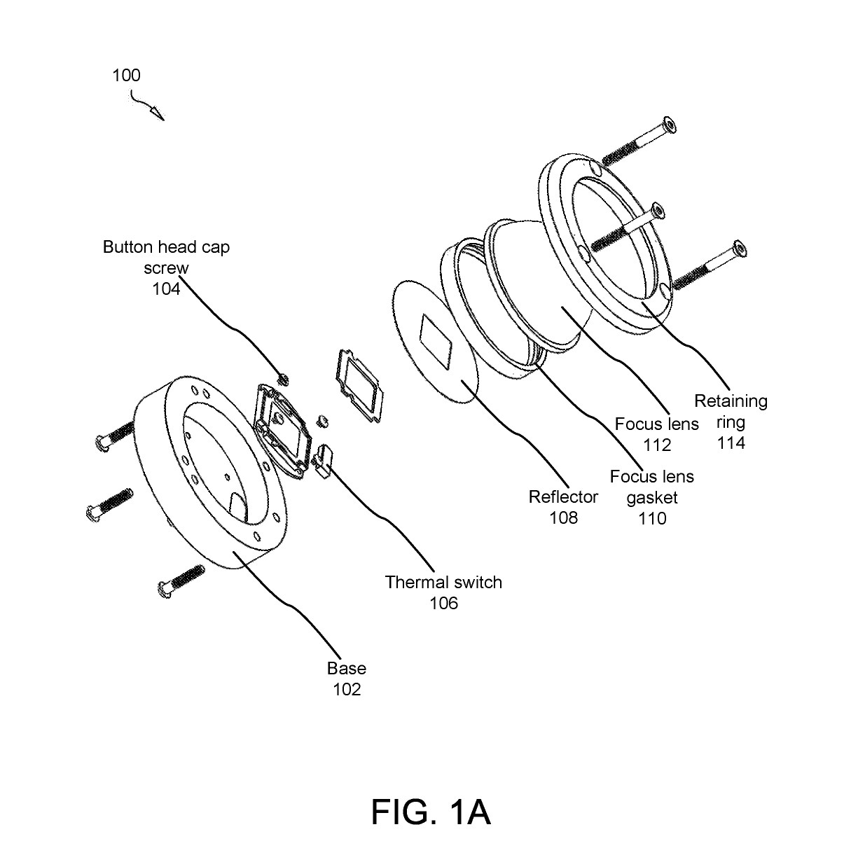

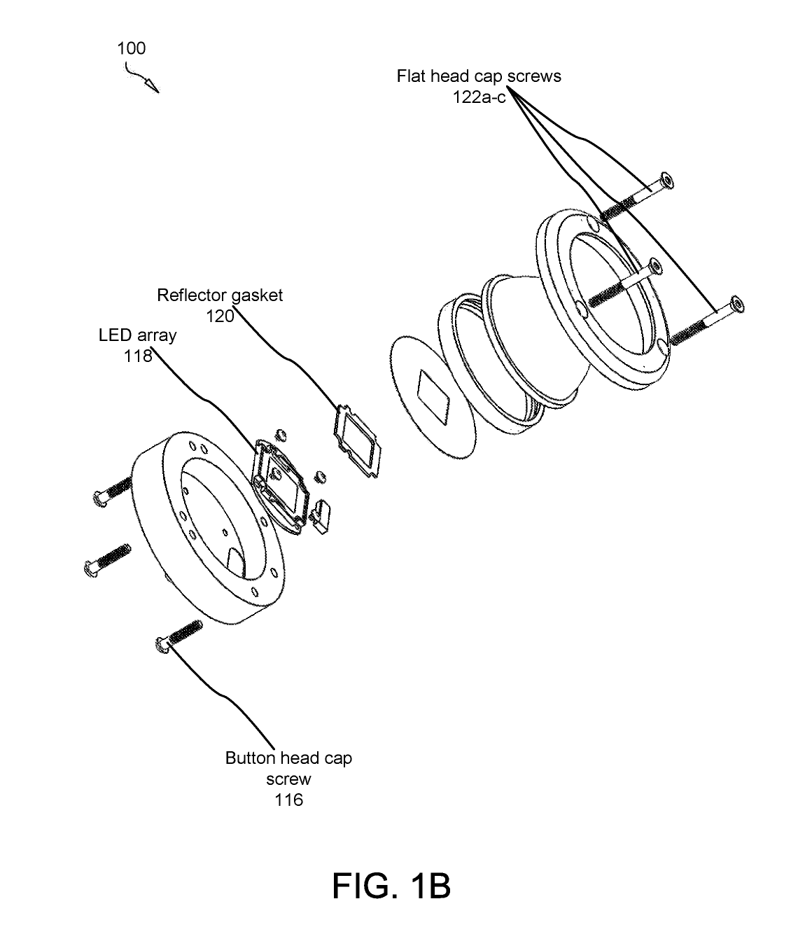

FIG. 1A-1B illustrate forward elevational side perspective views of a disassembled submersible marine light 100 in accordance with the present invention. The light 100 comprises a base 102, a button head cap screw 104, a thermal switch 106, a reflector 108, a focus lens gasket 110, a focus lens 112, a retaining ring 114, a button head cap screw 116, an LED array 118, a reflector gasket 120, and flat head cap screws 122a-c.

The base 102 comprises a cylindrical housing member whose top surface defines a recess for receiving the LED array 118 and thermal switch 106. In various embodiments, the base 102 in bored, drilled or otherwise configured to define a plurality of tapped threaded apertures for receiving threaded ends of flat head cap screws or button head cap screws.

The LED array 118 may comprise chip on board (COB). In various embodiments, the COB LED array 118 is powered by 25 or 34 volt or higher input to produce optimal light output from the light 100, distinguishing the present invention from lower-output lights in the art. Twelve volt boat, watercraft or vessels electrical systems may be converted upwards using means known to those of skill in the art, including transformers, converters, boosters, and the like. In various embodiments, the light 100 is powered by a separate fan box 800 (further described below).

Light output from the light 100 is further amplified (or focused) using the focus lens 112 which directs light diffused from the LED array 118 into a more focused beam emitting from the focus lens 112.

The higher output LED array improves the present invention over the prior art by provided a higher output light 100 which eliminates the need to affix multiple lights to a hull surface.

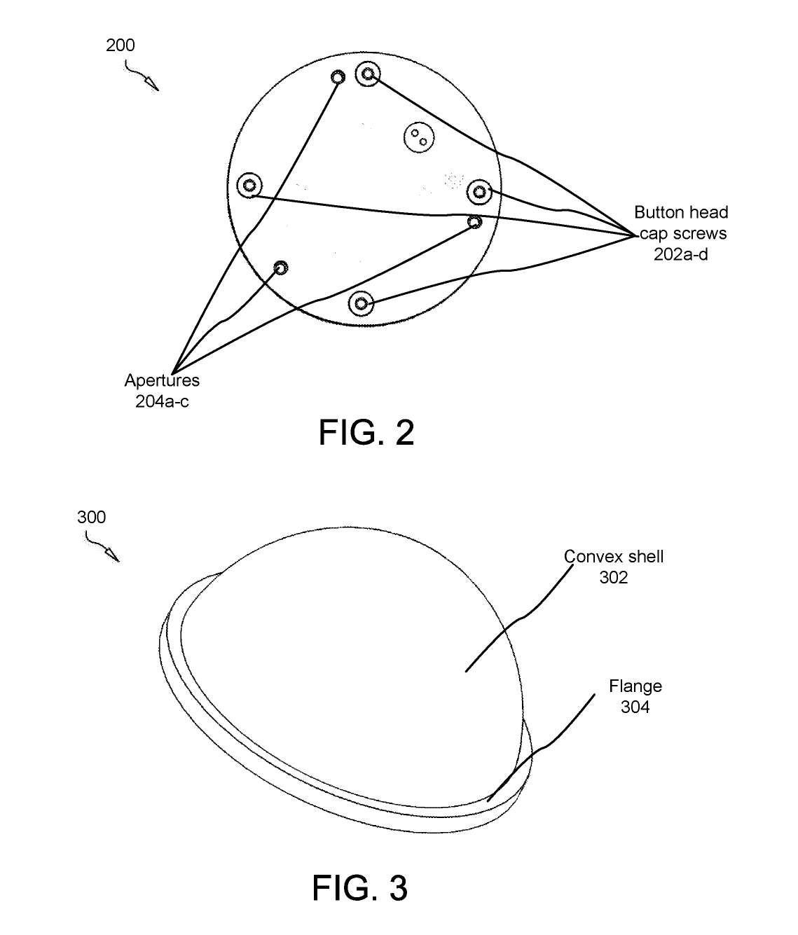

FIG. 2 is a lower perspective view of the base in accordance with the present invention. The base comprises a plurality of apertures 202, 204 for receiving threaded bolts. The base 102 may also comprise additional apertures for wires exiting or interconnecting the base 102 with a control box.

FIG. 3 is an elevational side perspective view of a convex lens in accordance with the present invention.

The focus lens 112 in convex from a top perspective view. The focus lens 112 comprises a flange 304 circumscribing the lens 112. In the preferred embodiment, the flange 304 and focus lens 112 are formed as a single integrated piece.

The focus lens 112 is disposed between the top surface of the base 102 and a bottom surface of an annular retaining ring 114.

The base 102 and retaining ring 114 may be fabricated from aluminum, stainless steel, titanium or other materials known to those of skill in the art.

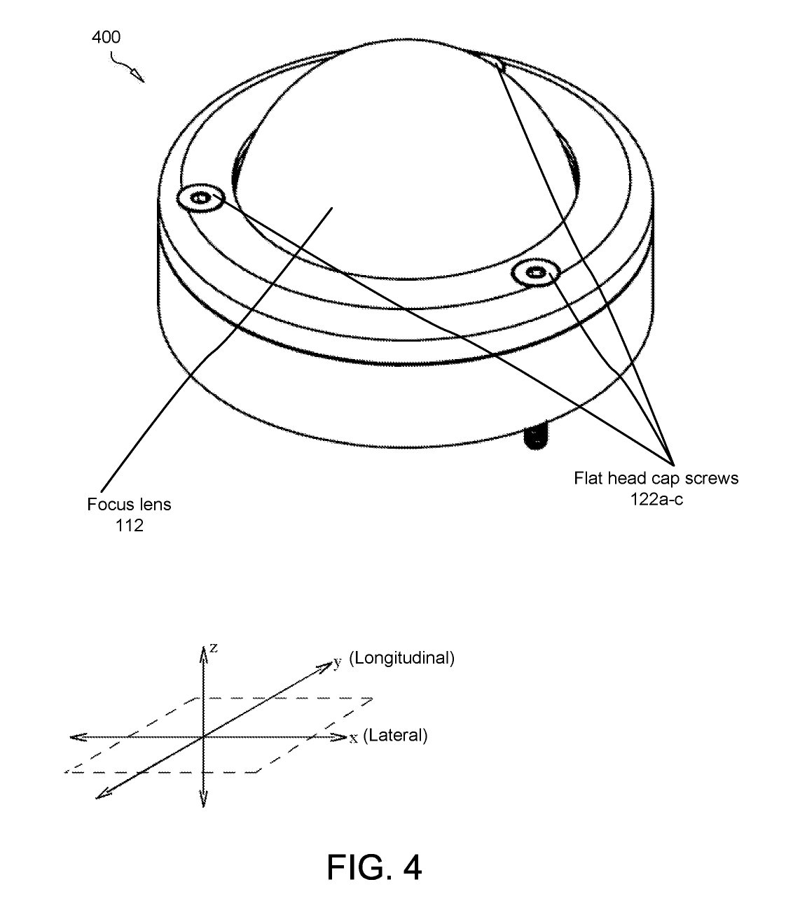

FIG. 4 is an elevational side perspective view of an assembled submersible marine lighting apparatus in accordance with the present invention.

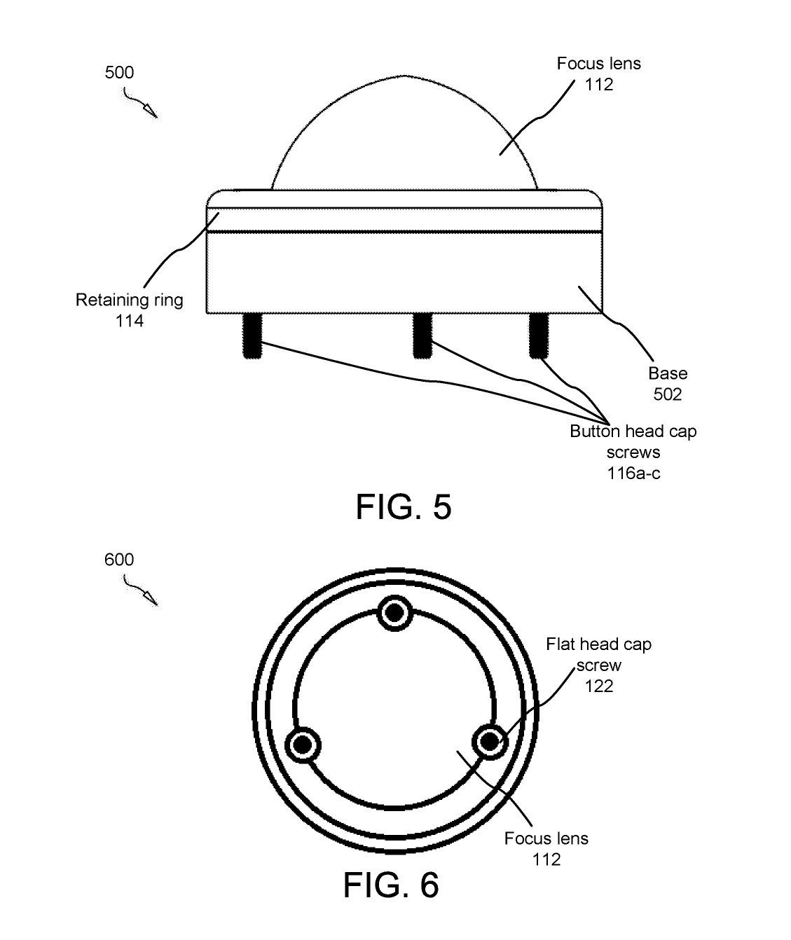

FIG. 5 is a side perspective view of a submersible marine lighting apparatus in accordance with the present invention.

As shown, the retaining ring 114 is mounted on the base 502 around the focus lens 112. A plurality of button head cap screws 116 insert into the base 102 through the hull of a ship or watercraft.

FIG. 6 is a top perspective view of a submersible marine lighting apparatus in accordance with the present invention showing flat head cap screws 112 and domed focus lens 112.

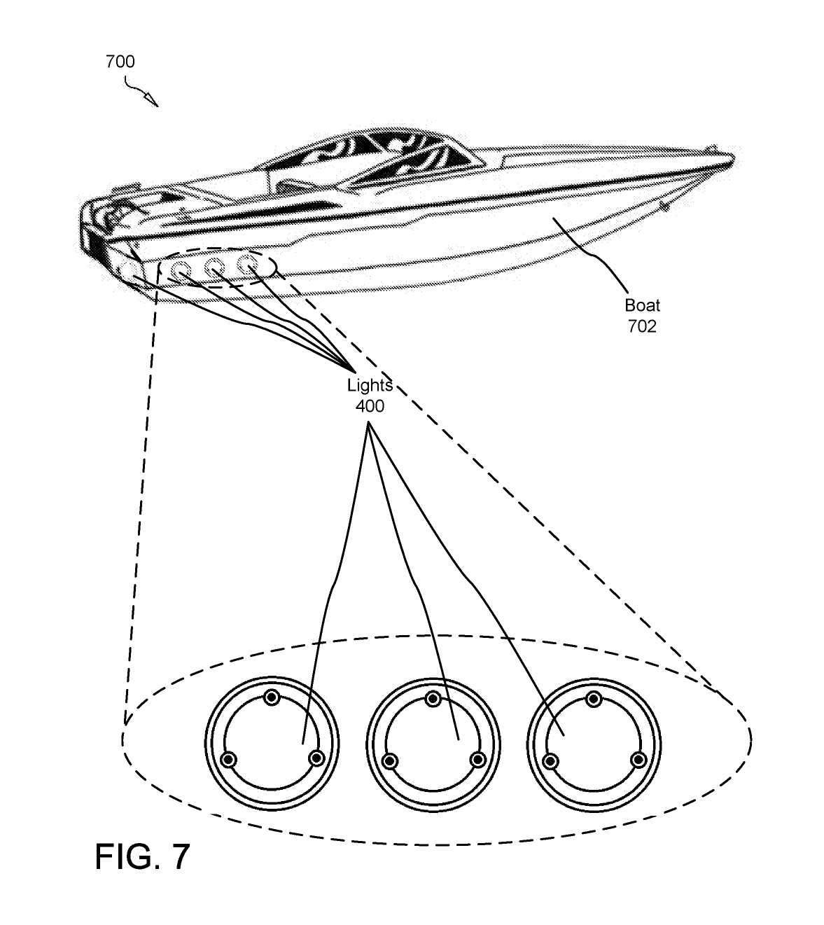

FIG. 7 is an exploded environmental side perspective view of a submersible marine light in accordance with the present invention.

The lights 400 may disposed alongside the hull of a boat 702 or on the stern below the waterline.

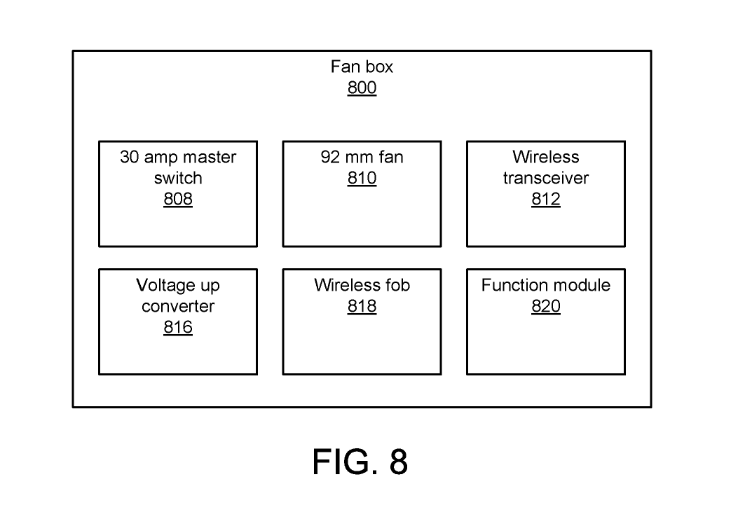

FIG. 8 is a block diagram of a fan box 800 for controlling input to a submersible light in accordance with the present invention.

In various embodiments, the voltage up converter with thermal protection, short circuit protection, and under voltage protection may be housed either in the recess defined by the base 102 or a separate fan-cooled housing 800 configured to be operable wirelessly. The fan may be a 92 milimeter cooling fan 810. In various embodiments, this separate housing comprises an extruded aluminum box with a 30 amp master switch 808 controlled by a wireless fob 818.

The luminous intensity of the COB LED is increased by the focus effect of the focus lens 112. This luminous intensity is measured in candela (or alternatively lux or lumens). The luminous intensity, and candela, of the COB LED may greater when measured behind the convex portion of the focus lens, and such is an object of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A submersible light comprising:
a base for affixation to a hull of a watercraft, the base defining a recess for receiving an LED array;
an LED array;
a thermal switch;
a plano-convex lens disposed between the base and a retaining ring for focusing light diffusing from the LED array, the plano-convex lens having a circumscribing flange;
wherein the retaining ring is bolted to the base.

2. The apparatus of claim 1, further comprising a reflector disposed between the plano-convex lens and the base.

3. The apparatus of claim 1, wherein the retaining ring is bolted to the base using three flat head screws.

4. A submersible marine light comprising:
a cylindrical base for affixation to a hull of a watercraft, the base defining a recess for receiving an LED array;
an LED array;
a thermal switch in logical connectivity with the LED array;
a plano-convex lens disposed between the base and a retaining ring for focusing light diffusing from the LED array, the plano-convex lens having a circumscribing flange;
a lens gasket disposed between the plano-convex lens and the base;
wherein the retaining ring is bolted to the base.
